(19) United States
(12) Patent Application Publication
(10) Pub. No.: US 2019/0012418 A1
(43) Pub. Date: Jan. 10, 2019

(54) SIMULATION PROGRAM, METHOD, AND DEVICE

(71) Applicant: FUJITSU LIMITED, Kawasaki-shi (JP)

(72) Inventors: Katsuhiro Yoda, Kodaira (JP); Takahiro Notsu, Kawasaki (JP); Mitsuru Tomono, Higashimurayama (JP)

(73) Assignee: FUJITSU LIMITED, Kawasaki-shi (JP)

(21) Appl. No.: 16/026,488

(22) Filed: Jul. 3, 2018

(30) Foreign Application Priority Data
Jul. 6, 2017 (JP) 2017-133101

(51) Int. Cl. G06F 17/50

(52) U.S. Cl. CPC G06F 17/5031

(57) ABSTRACT

A simulation method performed by a computer for simulating a synchronous transfer between a plurality of cores, the method including steps of: performing processing for the synchronous transfer in each of the cores as a set of interrupt and interrupt wait processing; simulating a cycle for the synchronous transfer at a timing when reception of notifications of the interrupts from all the plurality of cores is completed; and synchronizing the cores by notifying the cores of interrupt responses to the interrupt wait processing executed in the cores at the timing.

### CROSS-REFERENCE TO RELATED APPLICATION

This application is based upon and claims the benefit of priority of the prior Japanese Patent Application No. 2017-133101, filed on Jul. 6, 2017, the entire contents of which are incorporated herein by reference.

### FIELD

The embodiment discussed herein is related to a simulation program, method, and device for an integrated circuit including multiple cores.

### BACKGROUND

With advances in process technology, the degree of integration of a large scale integrated circuit (LSI) has been so increased that a system LSI may be mounted on a single chip. For example, many multi-core (multiple cores) systems in each of which multiple cores of a central processing unit (CPU) are mounted on a single chip have been developed, and the number of the cores mounted in the single chip has been increased. In these years, it has been desired to implement more complicated architecture in order to satisfy the performance demands, but problems due to such architecture are thus likely to occur. The architecture herein is a hardware configuration of the LSI, which includes the numbers, the sizes, and the connection topology of cores and memories.

In development of such an LSI, there has been known a technique for reducing design man-hours by using hardware designing based on architecture that is determined according to evaluation on not a model with hardware description but an abstracted performance model. When simulating resource contention between cores with this technique, information on bus accesses is extracted from operation results based on the simulations of the cores, and this information is used as resource access operation descriptions for the cores (for example, Japanese Laid-open Patent Publication Nos. 2014-215768 and 2004-021907).

When the conventional technique simulates operation of synchronous transfer of data between multiple cores, actual data transfer processing in the synchronous transfer has to be described and executed for all the cores. For this reason, when there is a considerable amount of data transfer between the cores and there are a large number of parallel cores, a problem arises in that the amount of simulation processing for one cycle execution is so increased that it takes long time to perform the simulation.

Thus, an object of one aspect of the present disclosure is to reduce processing loads and time of simulation of a multi-core configuration.

### SUMMARY

According to an aspect of the invention, a simulation method performed by a computer for simulating a synchronous transfer between a plurality of cores, the method including steps of: performing processing for the synchronous transfer in each of the cores as a set of interrupt and interrupt wait processing; simulating a cycle for the synchronous transfer at a timing when reception of notifications of the interrupts from all the plurality of cores is completed; and synchronizing the cores by notifying the cores of interrupt responses to the interrupt wait processing executed in the cores at the timing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram of development process of a multi-core LSI system;

FIG. 2 is a diagram that illustrates an example of performance estimation of architecture;

FIG. 3 is an explanatory diagram of a model description of a multi-core LSI system with an RTL model;

FIG. 4 is an explanatory diagram of a model description of a multi-core LSI system with a performance model;

FIG. 5 is an explanatory diagram of resource contention;

FIG. 6 is an explanatory diagram of a model development method that is capable of duplicating the resource contention while reducing loads of the simulation;

FIG. 7 is a first explanatory diagram of synchronous transfer processing between multiple cores;

FIG. 8 is a second explanatory diagram of synchronous transfer processing between multiple cores;

FIG. 9 is an explanatory diagram of an embodiment;

FIG. 10 is a block diagram that illustrates a configuration example of a simulation device of the embodiment;

FIG. 11 is a flowchart that illustrates a processing example of a synchronous transfer converter;

FIG. 12 is a flowchart that illustrates a processing example of an interrupt controller; and

FIG. 13 is a diagram that illustrates an example of a hardware configuration of the simulation device (computer) corresponding to each embodiment.

### DESCRIPTION OF EMBODIMENT

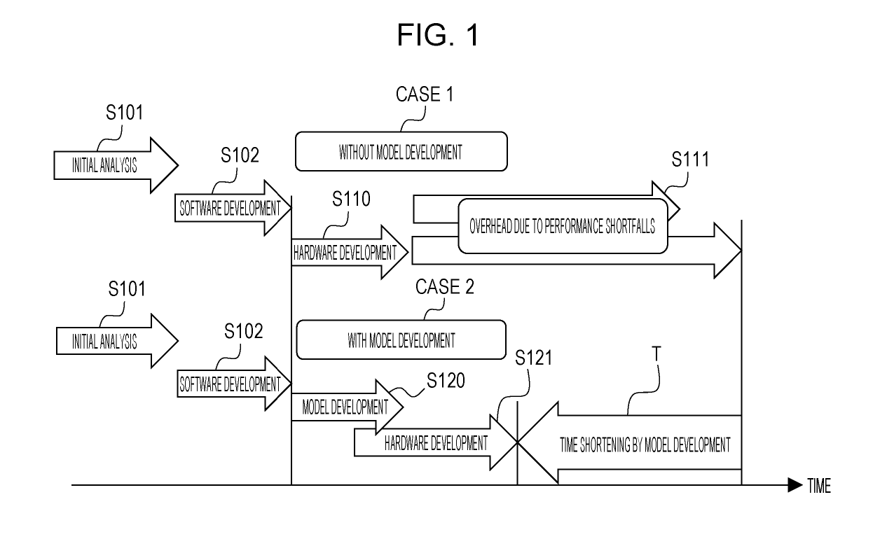

Hereinafter, embodiments of the present disclosure are described in detail with reference to the drawings. FIG. 1 is an explanatory diagram of development process of a multi-core LSI system to which the embodiments of the present disclosure may be applied.

First, after initial analysis including determination of demand specifications (step S101), software development starts (step S102). In the software development, application software corresponding to a functionality installed in an LSI is developed. For example, communication software of 4G communication functionality is developed for a wireless LSI.

Thereafter, there may be a case 1 without model development and a case 2 with model development as the development process.

When the case 1 without the model development is employed as the development process, hardware that is capable of implementing a functionality of the software developed in the software development in step S102 is directly developed (step S110). In this case, the development is performed while determining topology of the hardware that implements the functionality of the software based on experience. If this hardware does not achieve expected performance, the topology has to be changed. The more architecture becomes complicated, the more performance shortfalls occur after the hardware development, and reworks on the development have to be performed (step S111).

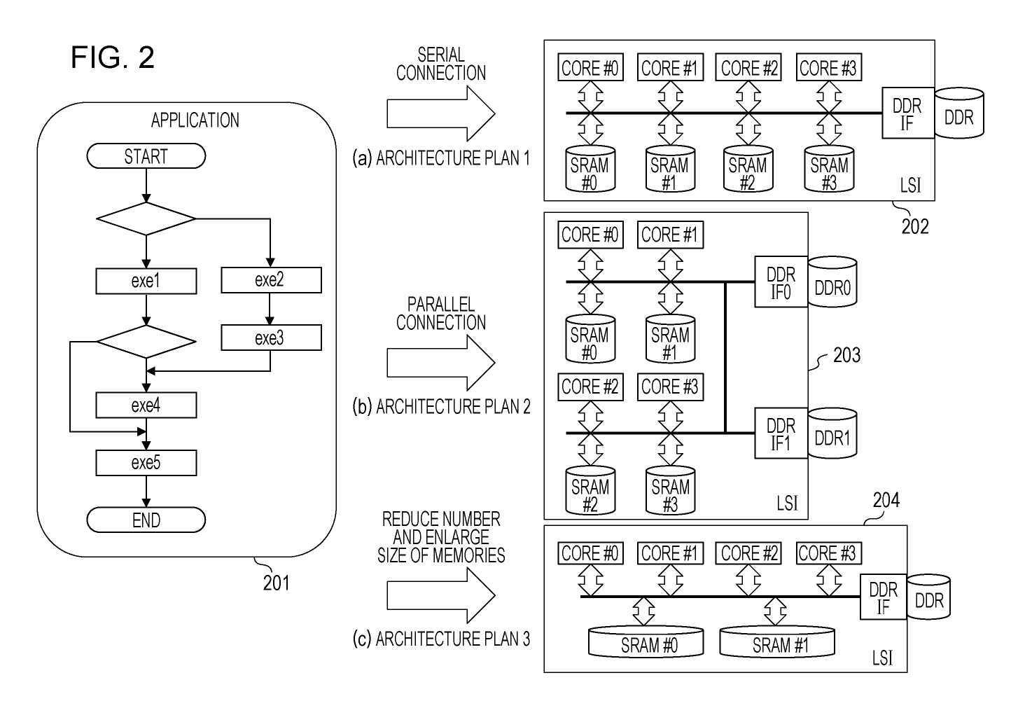

On the other hand, when the case 2 with the model development is employed as the development process, application is moderately determined by the software development in step S102 before the hardware development, and the model development is then performed for estimating the performance of the architecture (step S120). FIG. 2 is a diagram that illustrates an example of the performance estimation of the architecture in the model development. First, application 201 to be implemented is determined by the software development in step S102 of FIG. 1. In this application 201, from start to end of the execution, various processing such as exemplified exe1, exe2, exe3, exe4, and exe5 is executed according to conditional branching. Next, corresponding to such a configuration of the application 201, LSI models 202, 203, and 204 of different architecture plans with different topology and memory configurations are created and then executed as illustrated in (a), (b), (c) of FIG. 2. For example, in the LSI model 202 of an architecture plan 1 of (a) of FIG. 2, cores #0 to #3 as individual processors and static random access memories (SRAMs) #0 to #3 are respectively connected via a bus (serial connection configuration). In the LSI model 203 of an architecture plan 2 of (b) of FIG. 2, a group in which the cores #0 and #1 and the SRAMs #0 and #1 are respectively connected via a bus and a group in which the cores #2 and #3 and the SRAMs #2 and #3 are respectively connected via a bus are made, and these groups are further connected via a bus (parallel connection configuration). In addition, in the LSI model 204 of an architecture plan 3 of (c) of FIG. 2, the SRAMs #2 and #3 are deleted from the LSI model 202 of the architecture plan 1 of (a) of FIG. 2, and each size of the SRAMs #0 and #1 is enlarged. After searching for an LSI model having architecture with high performance (short processing time) from these some developed LSI models, the hardware is designed based on that architecture (step S121 of FIG. 1).

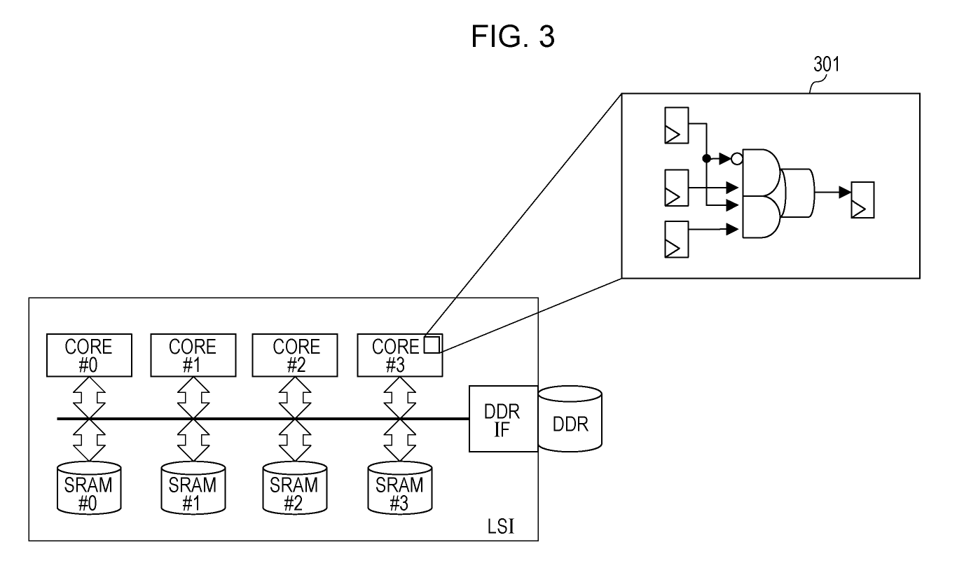

There is known a register transfer level (RTL) model as an example of the model employed in the model development. In the RTL model, the minimum part corresponding to a sequential circuit such as a latch circuit having state information is abstracted as a “register” in a logic circuit. Then, operation of the logic circuit is described as a set of transfers each from one register to another register and logical computations performed by combinational logic circuits in the transfers. FIG. 3 is an explanatory diagram of a model description of a multi-core LSI system with the RTL model. When the multi-core LSI system is modeled as the RTL model, the model is described in consideration of the logic circuit in each core, and switching of logics by that logic circuit is simulated as illustrated by 301 in FIG. 3.

However, since the RTL model is a highly detailed model, the LSI system becomes more complicated, and especially in a case of the multi-core configuration, the description using the RTL model becomes more difficult. This results in increase of the number of work steps and increase of simulation time.

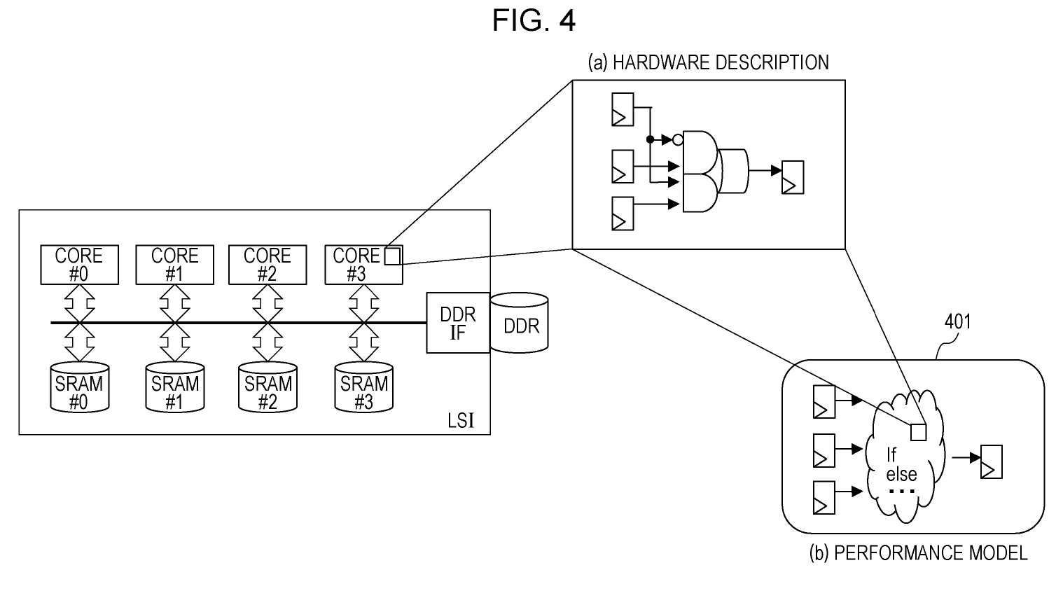

To deal with this, there is known a performance model as another model example employed in the model development. FIG. 4 is an explanatory diagram of the model description of the multi-core LSI system with the performance model. For example, in the performance model, a hardware description of (a) of FIG. 4 is replaced by a description in a programming language form as a diagram denoted by 401 in (b) of FIG. 4 using a hardware description language called SystemC, which is provided as a class library of the C++ programming language. In this class library, various functions of a functionality, a parallel execution concept, and a time concept for the hardware description are defined. A program may be compiled by a C++ compiler, and a thus generated object operates as a simulator of the hardware. Such a performance model is capable of describing the logic of the hardware in high abstraction level. Use of the performance model makes it possible to develop the LSI system having a complicated configuration.

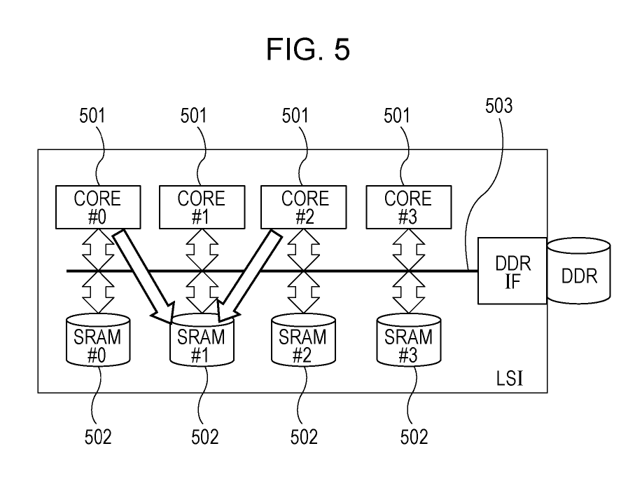

Next, development process of the multi-core LSI system including multiple cores is described. Since a simulator for single core usually accompanies the core, the performance estimation with the single core may be made by the performance model such as the above-described SystemC. In this case, resource contention between the multiple cores may occur in the multi-core LSI system. FIG. 5 is an explanatory diagram of the resource contention. In FIG. 5, the resource contention may occur when the core 501(#0) and the core 501(#2) access the same SRAM 502(#1) via a bus 503, for example. However, it is impossible to simulate such resource contention by the above-described performance estimation with the single core.

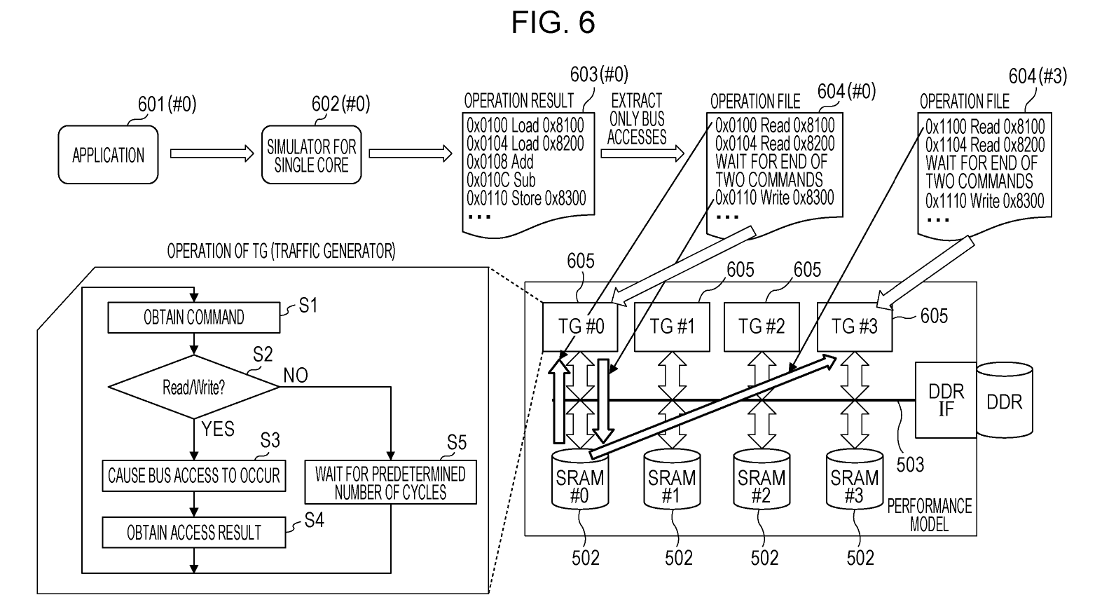

FIG. 6 is an explanatory diagram of a model development method that is capable of duplicating the resource contention while reducing loads of the simulation. FIG. 6 depicts as an example the development of the multi-core LSI system including four cores 501(#0) to 501(#3) and four SRAMs 502(#0) to 502(#3) illustrated in FIG. 5. Description is given below referring to those constituents illustrated in FIG. 5 with reference numbers in FIG. 5.

First, application 601(#0) for the core 501(#0) developed in step S102 of FIG. 1 is executed by a simulator 602(#0) for single core that simulates the core 501(#0), for example. As a result, log information indicating what command is executed in what time is obtained as an operation result 603(#0).

Next, the operation result 603(#0) is divided into information to be processed in the core 501(#0) and information to be processed outside the core 501(#0) and is extracted as an operation file 604(#0) including log information on commands associated with access via the bus 503.

In the example of FIG. 6, Add and Sub are the commands for only inside the core 501(#0) and not associated with access to the outside. Thus, Add and Sub are combined and replaced with information that indicates waiting for end of two commands (no access to the outside). Commands may be individually replaced with information that indicates waiting for end of one command; however, in a case of ten thousand lines of commands for example, the volume of the information may be made into one hundredth by combining those multiple commands and replacing them with information that indicates waiting for end of the multiple commands.

In the example of FIG. 6, a Load command is a command for reading from, for example, the SRAM 502(#0) outside the core 501(#0); thus, the Load command is recorded as one-time read in the operation file 604(#0). Concurrently, a program counter address (for example, “0x0100”) and a load-store address (for example, “0x8100”) of that Load command are copied from the operation result 603(#0). Likewise, since a Store command is a command for writing into, for example, the SRAM 502(#0) outside the core 501(#0), the Store command is recorded as one-time write in the operation file 604(#0). Concurrently, the program counter address (for example, “0x0110”) and the load-store address (for example, “0x8300”) of that Store command are copied from the operation result 603(#0).

There may be following two ways for recording the log information in the operation file 604(#0) in this case. The first way is that to record only the program counter address (for example, “0x0100”) as the log information. When programs are sequentially provided from each program address on the SRAM 502(#0) for example, there is description for what to do, and the bus access is performed in accordance with that description. On the other hand, in the second way, operation corresponding to a command (for example, “read” or “write”), the program counter address (for example, “0x0100”), and an address of data to which that command accesses (load-store address) (for example, “0x8100”) are recorded as the log information. When simulating execution of that command, the read/write access caused by that command and the read access to the program counter are both executed. The following description employs this second way.

Next, in FIG. 6, corresponding to the cores 501(#0) to 501(#3) (see FIG. 5), simulators called traffic generators (TGs) 605(#0) to 605(#3) are provided. For example, the TG 605(#0) executes sequential processing illustrated as steps S1 to S6 of FIG. 6 by reading the operation file 604(#0) generated as described above. That is, the TG 605(#0) obtains the operation of the commands in the order from top of the operation file 604(#0) (step S1) and determines whether each operation is either “read” or “write” (step S2). When the operation is “read” or “write,” the TG 605(#0) causes access to, for example, any one of the SRAMs 502(#0) to 502(#3) via the bus 503 (step S3) and obtains an access result (step S4). When that operation is neither “read” or “write,” the TG 605(#0) waits for the designated commands number of cycles (step S5). After the processing of steps S4 and S5, the TG 605(#0) returns to step S1 and processes the next command operation.

Likewise, for each of the cores 501(#1) to 501(#3) (see FIG. 5), the processing of obtaining the operation results 603 and the conversion into the operation files 604 are executed based on similar processing by the corresponding simulators 602 for single core as the one described above. On the operation files 604(#1) to 604(#3) (in FIG. 6, only #0 and #3 are illustrated as an example) obtained by the processing, the simulation processing illustrated as steps S1 to S5 are executed by the TGs 605(#1) to 605(#3).

The TGs 605 are usually described with a highly abstracted model having the time concept, such as SystemC. The access operation to the bus 503 in each of the TGs 605(#0) to 605(#3) are also described with SystemC. Assuming that how to behave when the resource contention occurs due to concurrent access to the SRAMs 502(#0) to 502(#3) in FIG. 6 is described with SystemC in advance. The details of the performance model made by the TGs 605 are similar to those of the technologies discussed in Japanese Laid-open Patent Publication Nos. 2014-215768 and 2004-021907, for example.

As described above, by operating the cores 501 while abstracting them as the TGs 605, desired operation may be executed while reducing loads of the performance model without lowering the accuracy. Specifically, the TGs 605 are able to express the behavior for the resource contention at a certain time.

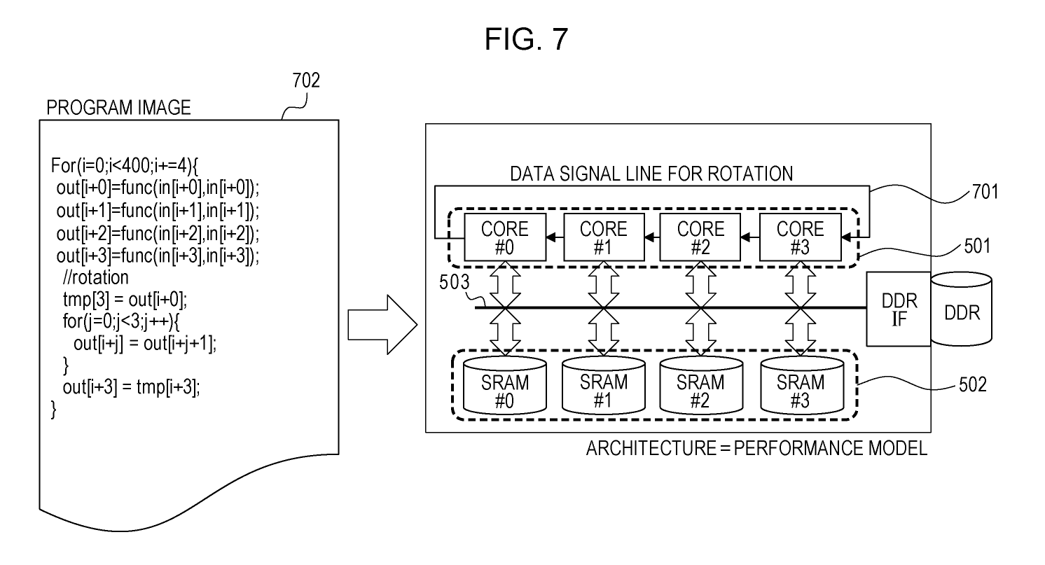

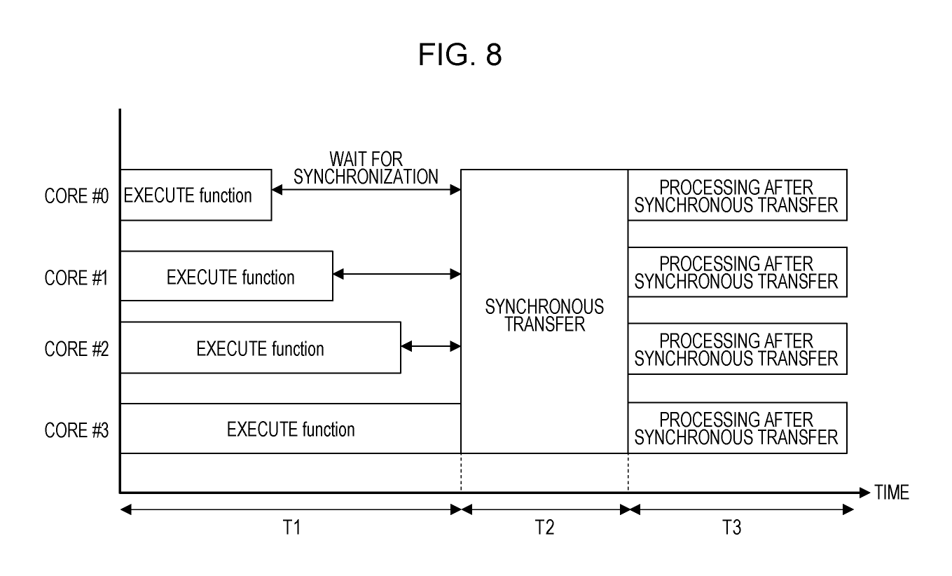

Here, simulation of synchronous transfer processing between the multiple cores 501 is described. FIGS. 7 and 8 are explanatory diagrams of the synchronous transfer processing between the multiple cores. For example, in a program image 702 illustrated in FIG. 7, 400 loops of the same function processing (a part following “func” in FIG. 7) are executed by all the multiple cores 501(#0) to 501(#3). Assuming that the cores 501 synchronously rotate data of these processing results via a data signal line 701 for the rotation routed along the cores 501. The rotation is defined as processing of inputting an output of the core 501(#0) to the core 501(#3), inputting an output of the core 501(#3) to the core 501(#2), inputting an output of the core 501(#2) to the core 501(#1), and inputting an output of the core 501(#1) to the core 501(#0). These loops are allocated in parallel to the cores 501(#0) to 501(#3) such that (multiples of 4)-th loops are allocated to the core 501(#0), (multiples of 4+1)-th loops are allocated to the core 501(#1), (multiples of 4+2)-th loops are allocated to the core 501(#2), and (multiples of 4+3)-th loops are allocated to the core 501(#3). That is, this is a case where the multiple cores 501 execute processing with the same operation sequence but different input data in parallel and also the data is synchronized during that execution.

The design for this case is that execution timing of the function processing (func) in each of the cores 501 is different in a time period T1 in FIG. 8, and the function execution is all synchronized at the same time in a time period T2 to execute the above-described rotation processing after completion of the function processing (func) with all the cores 501(#0) to 501(#3), and then, after the time period T2 ends, processing after the synchronous transfer is executed with each of the cores 501 in a time period T3.

In this case, in the performance model described in FIG. 6, the data line between the cores 501 and the transfer through the data line are described with the model. However, when the multi-core LSI system includes over 100 cores 501 and the number of loops is over ten thousand, the simulation of the rotation spent significant time.

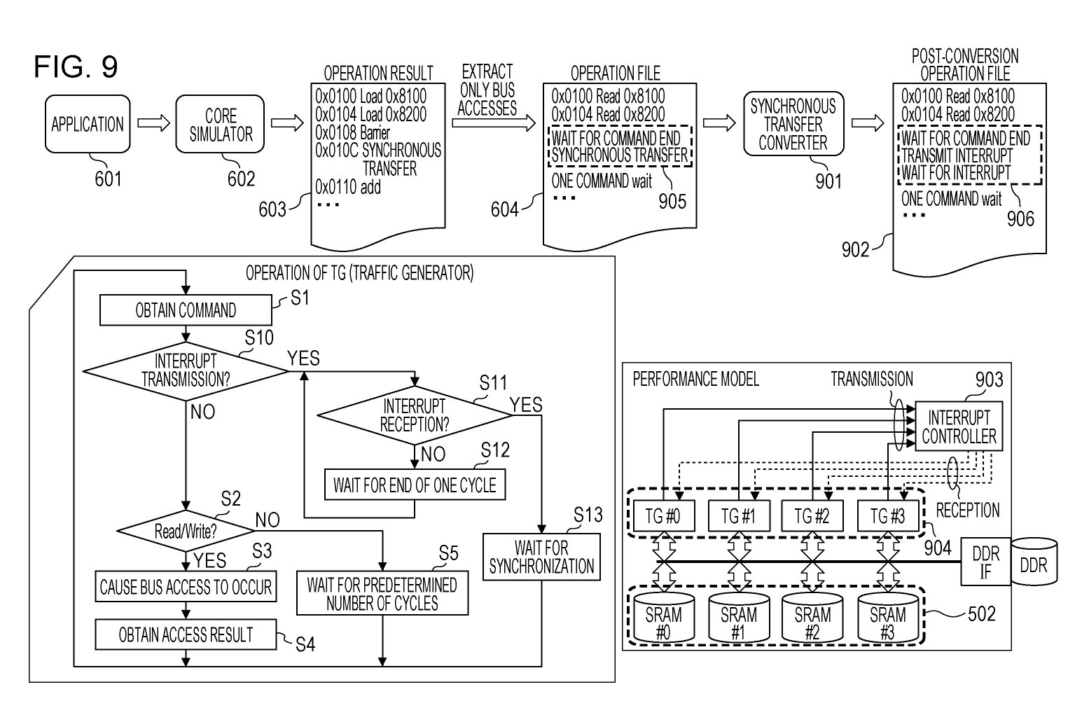

FIG. 9 is an explanatory diagram of this embodiment to solve the above problems. In this embodiment, similar to the case of FIG. 6, the applications 601 of the cores 501 (see FIG. 5) developed in step S102 of FIG. 1 are executed by the simulators 602 for single core that simulate the cores 501. As a result, the operation results 603 in which the log information on the command execution is recorded are obtained. In addition, the operation files 604 including the log information on commands associated with the access to the SRAMs 502 via the bus 503 (resource access operation descriptions) is extracted from the operation results 603.

Next, a synchronous transfer converter 901 converts processing 905 of the synchronous transfer in the cores 501 (command for rotation processing) to a set 906 of interrupt transmission processing and interrupt wait processing and generates post-conversion operation files 902.

Meanwhile, as a performance model in the simulation, the data signal line 701 for the rotation in FIG. 7 is removed and an interrupt controller 903 is arranged. Data lines for interrupt transmission are wired from the respective cores 501 to the interrupt controller, and data lines for interrupt reception (response) are wired from the interrupt controller 903 to the respective cores 501.

In addition, in the above-described performance model, sequential processing of steps S10 to S13 in FIG. 9 is added in addition to steps S1 to S5 in FIG. 6 to the operation algorithm of the TGs 605 described in FIG. 6.

The TGs 605 that operate corresponding to the cores 501 obtain operation of a command in each line in the order from top of the post-conversion operation files 902 (step S1).

Next, the TGs 605 determine whether the operation of the command obtained in step S1 is operation of the interrupt transmission (step S10).

When the determination in step S10 is NO, the same processing of steps S2 to S5 as that in FIG. 6 is executed. That is, first, the TGs 605 determine whether the operation of the command obtained in step S1 is operation either “read” or “write” associated with access via the bus 503 (step S2).

When the determination in step S2 is YES, the TGs 605 cause bus access, which is access to the SRAMs 502 via the bus 503 (step S3), and obtains an access result (step S4). Thereafter, the TGs 605 return to step S1 and obtain the operation of the command in the next line from the post-conversion operation files 902.

When the determination in step S2 is NO, the TGs 605 execute operation of waiting for cycles of the number of the commands designated in the line (step S5). Thereafter, the TGs 605 return to step S1 and obtain operation of a command in the next line from the post-conversion operation files 902.

When the command obtained in step S1 is an interrupt transmission command (when the determination in step S10 is YES), the TGs 605 execute the interrupt transmission on the interruption controller 903 and thereafter determine whether there is the interrupt reception from the interrupt controller 903 (step S11).

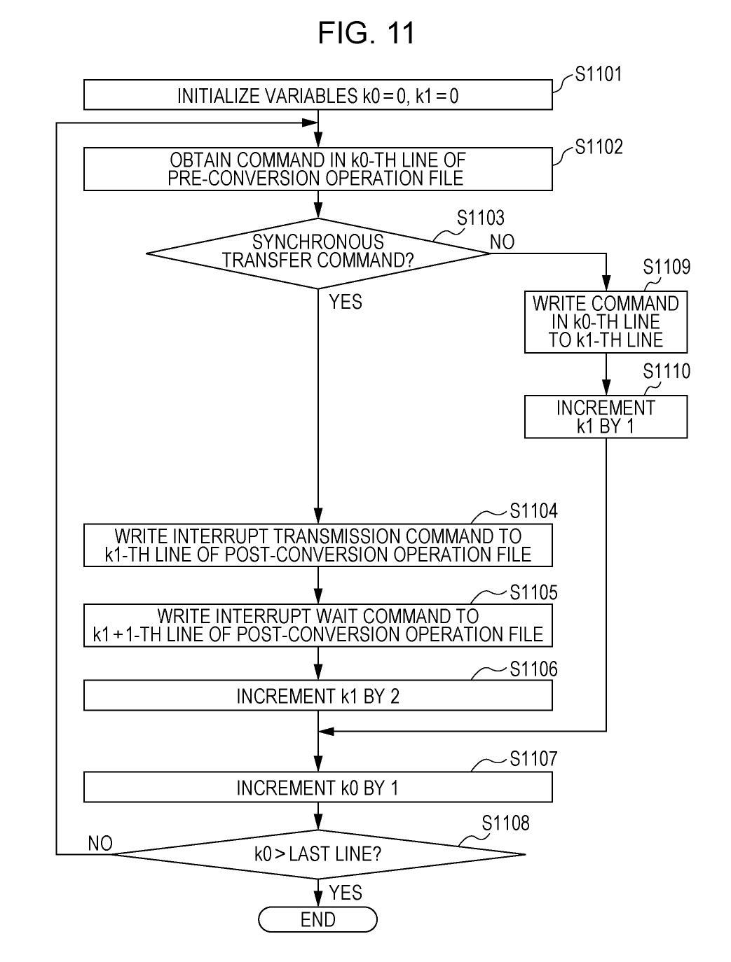

When the determination in step S11 is NO, the TGs 605 waits for one cycle (step S12) and then repeats the determination in FIG. 11.

The interrupt controller 903 monitors an interrupt transmission signal from each of the cores 501, and after confirming that the interrupt transmission signals come from all of the predetermined one or more cores 501, returns a response signal to the above-described cores 501.

When there is the interrupt reception from the interrupt controller 903 (when the determination in step S11 is YES), the TGs 605 wait for the number of cycles for the predetermined synchronous transfer (step S13). Thereafter, the TGs 605 return to the processing in step S1 and obtain the operation of the command in the next line from the post-conversion operation files 902.

According to the above-described control operation of the TGs 605 and the interrupt controller 903, the performance model in FIG. 6 directly simulates the transfer operation for the synchronous transfer, and thus the simulation cost becomes high; however, in the performance model of this embodiment in FIG. 9, only the information for starting and ending of the synchronous transfer is controlled with the interruption, and thus it is possible to significantly reduce the simulation cost of the data transfer.

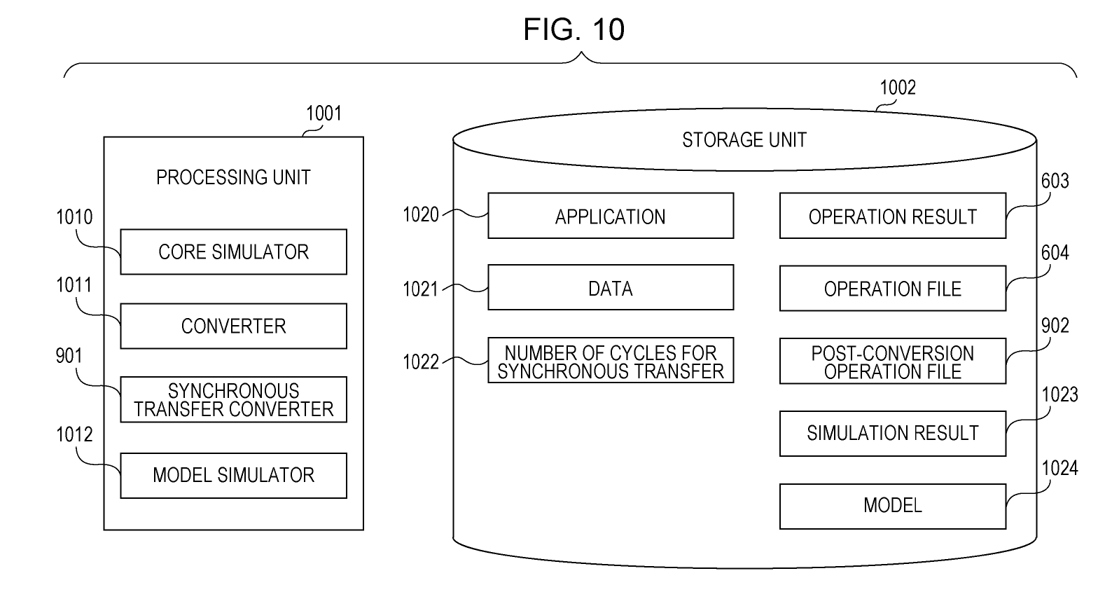

FIG. 10 is a block diagram that illustrates a configuration example of a simulation device of this embodiment that implements the operation of this embodiment described in FIG. 9. The intended multi-core LSI system is similar to that in the above-described FIG. 5, and description is given below referring to not only those constituents illustrated in FIG. 5 with the reference numbers in FIG. 5 but also the constituents illustrated in FIG. 9 with reference numbers in FIG. 9. The simulation device of this embodiment includes a processing unit 1001 and a storage unit 1002.

The processing unit 1001 includes a core simulator 1010, a converter 1011, the same synchronous transfer converter 901 as that in FIG. 9, and a model simulator 1012.

The core simulator 1010 corresponds to the simulators 602 for single core in FIG. 9 and executes single simulation for each of the cores 501 in FIG. 5.

The converter 1011 extracts the operation files 604 associated with the cores 501 (resource access operation descriptions) from the operation results 603 (see FIG. 9) of the cores 501 in the core simulator 1010.

The synchronous transfer converter 901 executes operation similar to that of the synchronous transfer converter 901 in FIG. 9 to convert the processing 905 of the synchronous transfer in the operation files 604 to the set 906 of the interrupt transmission processing and the interrupt wait processing and generate the post-conversion operation files 902.

The storage unit 1002 stores an application 1020, data 1021, the number of cycles for the synchronous transfer 1022, the operation results 603, the operation files 604, the post-conversion operation files 902, a simulation result 1023, and a model 1024.

The application 1020 corresponds to the application 601 of FIG. 9. The data 1021 is various kinds of data used in the application 1020.

The number of cycles for the synchronous transfer 1022 is data storing the number of cycles that the TGs 605 wait during the synchronous transfer processing.

Each of the operation results 603, the operation files 604, and the post-conversion operation files 902 correspond to the data described in FIG. 9.

The simulation result 1023 is data as a result from the simulation executed by the model simulator 1012.

The model 1024 is data of the performance model handled by the model simulator 1012. FIG. 11 is a flowchart that illustrates an operation example of processing executed by the synchronous transfer converter 901 in the processing unit 1001 in the simulation device of this embodiment in FIG. 10. Description is given below referring to those constituents illustrated in FIG. 10 with the reference numbers in FIG. 10.

First, the synchronous transfer converter 901 initializes both variables k0 and k1 to 0 (step S1101). The variable k0 indicates a line number of the operation files 604, and the variable k1 indicates a line number of the post-conversion operation files 902.

Next, the synchronous transfer converter 901 obtains operation of a command in a k0-th line corresponding to a value indicated by the variable k0 in the pre-conversion operation files 604 (step S1102).

Next, the synchronous transfer converter 901 determines whether the operation of the command obtained in step S1102 is operation of the synchronous transfer command (step S1103).

When the determination in step S1103 is YES (a case of the part denoted by 905 in FIG. 9), the synchronous transfer converter 901 writes the interrupt transmission command to a k1-th line corresponding to a value indicated by the variable k1 in the post-conversion operation files 902 (step S1104).

Next, the synchronous transfer converter 901 writes an interrupt wait command to a k1+1-th line corresponding to a value k1 indicated by the variable k1 that is incremented by 1 in the post-conversion operation files 902 (step S1105).

The case of the above-described steps S1104 and S1105 corresponds to conversion processing from the part denoted by 905 of the operation files 604 to the part denoted by 906 of the post-conversion operation files 902 in FIG. 9.

After the processing of the above-described steps S1104 and S1105, the synchronous transfer converter 901 increments the variable k1 by 2 corresponding to the above-described two commands (step S1106) and increments the variable k0 by 1 to indicate the next line (step S1107).

On the other hand, when the determination in step S1103 is NO, the synchronous transfer converter 901 writes the command in the k0-th line corresponding to the value indicated by the variable k0 in the operation files 604 to the k1-th line corresponding to the value indicated by the variable k1 in the post-conversion operation files 902 (step S1109).

Thereafter, the synchronous transfer converter 901 increments the variable k1 by 1 corresponding to the writing of the above-described one command (step S1110) and increments the variable k0 by 1 to indicate the next line (step S1107).

After the above-described step S1107, the synchronous transfer converter 901 determines whether the value of the variable k0 exceeds a value corresponding to the last line of the pre-conversion operation files 604 (step S1108).

When the determination in step S1108 is NO, the synchronous transfer converter 901 returns to the processing of step S1102 and starts processing of the next line in the pre-conversion operation files 604.

When the determination in step S1108 is YES, the synchronous transfer converter 901 ends the processing indicated in the flowchart of FIG. 11.

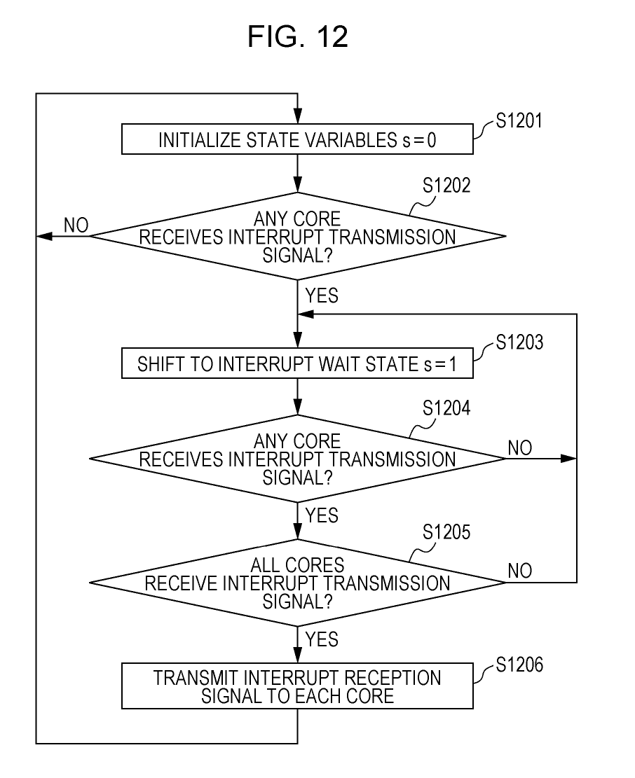

FIG. 12 is a flowchart that indicates a processing example of the interrupt controller 903 of FIG. 9. First, the interrupt controller 903 initializes a state variable s to 0 (not-waiting state) (step S1201).

Next, the interrupt controller 903 is in a waiting state until receiving the interrupt transmission signal from any one of the cores 501 in FIG. 9 (repeats NO in determination in step S1202->step S1201->NO in determination in step S1202).

Once the interrupt transmission signal is received from any one of the cores 501 (when the determination in step S1202 is YES), the interrupt controller 903 changes the value of the state variable s to a value 1, which indicates the waiting state (step S1203).

Thereafter, the interrupt controller 903 is in the waiting state until further interrupt transmission signal is received from another one of the cores 501 (repeats NO in determination in step S1204->step S1203->NO in determination in step S1204).

When the interrupt transmission signal is further received from the other one of the cores 501 (when the determination in step S1204 is YES), the interrupt controller 903 determines whether all the interrupt transmission signals are received from all of the predetermined cores 501 (step S1205).

When the determination in step S1205 is NO, the interrupt controller 903 returns to the processing in step S1203.

When the determination in step S1205 is YES, the interrupt controller 903 transmits an interrupt reception signal (response signal) to each of the predetermined cores 501 (step S1206). Thereafter, the interrupt controller 903 returns to the processing of step S1201.

According to the above-described processing of the interrupt controller 903 exemplified in the flowchart of FIG. 12, each of the cores 501 may notify the interrupt controller 903 of completion of execution of the function processing (func) in FIG. 8 by the interrupt transmission. In addition, the interrupt controller 903 may notify the cores 501 of timing of starting the synchronous transfer in the time period T2 in FIG. 8 when receiving the interrupt transmission signals from all of the predetermined cores 501. As a result, when the determination in step S11 is YES and after the synchronization waiting processing ends in step S13 in FIG. 9, the TGs 605 for the cores 501 may simulate the processing of starting the synchronous transfer at the same time.

As described above, this embodiment makes it possible to reduce the computation cost of the simulation by replacing the data transfer in the synchronous transfer between the cores 501 with the interrupt control signals.

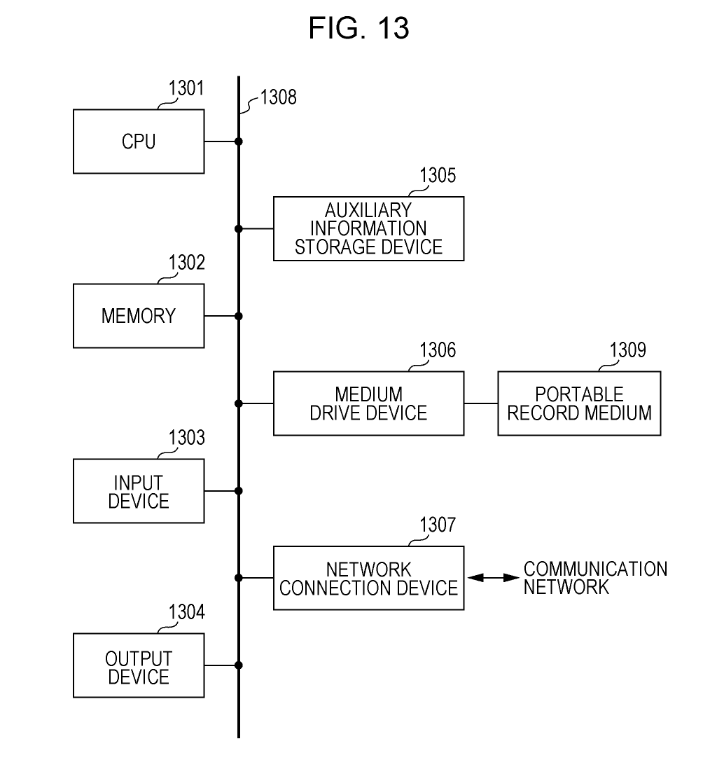

FIG. 13 is a diagram that illustrates an example of a hardware configuration of the simulation device (computer) corresponding to the above-described embodiment.

The computer illustrated in FIG. 13 includes a central processing unit (CPU) 1301, a memory 1302, an input device 1303, an output device 1304, an auxiliary information storage device 1305, a medium drive device 1306 to which a portable record medium 1309 is inserted, and a network connection device 1307. These constituents are connected with each other via a bus 1308. The configuration illustrated in FIG. 13 is an example of a computer that implements the above-described simulation device, and such a computer is not limited to this particular configuration.

For example, the memory 1302 is a semiconductor memory such as a read only memory (ROM), a random access memory (RAM), and a flash memory that stores a program and data used for processing.

For example, the CPU (processor) 1301 executes the program using the memory 1302 to operate as the processing unit 1001 illustrated in FIG. 10.

For example, the input device 1303 is a keyboard, a pointing device, and the like used for inputting an instruction and information from an operator or a user. For example, the output device 1304 is a display device, a printer, a speaker, and the like used for outputting an inquiry and a processing result to the operator or the user.

For example, the auxiliary information storage device 1305 is a hard disk storage device, a magnetic disk storage device, an optical disk device, a magnetic optical disk device, a tape device, or a semiconductor storage device, and, for example, operates as the storage unit 1002 illustrated in FIG. 10. The simulation device of FIG. 10 is capable of storing the program and the data in the auxiliary information storage device 1305 and using them by loading into the memory 1302.

The medium drive device 1306 drives the portable record medium 1309 and accesses the recorded contents therein. The portable record medium 1309 is a memory device, a flexible disc, an optical disc, a magnetic optical disc, and the like. The portable record medium 1309 may be a compact disk read only memory (CD-ROM), a digital versatile disk (DVD), a universal serial bus (USB) memory, and the like. The operator or the user may store the program and the data in this portable record medium 1309 and may use them by loading into the memory 1302.

As described above, the computer-readable record medium that stores the program and the data used for the simulation processing of the simulation device of FIG. 10 is a physical (non-transitory) record medium such as the memory 1302, the auxiliary information storage device 1305, and the portable record medium 1309.

For example, the network connection device 1307 is a communication interface that is connected to a communication network such as the local area network (LAN) to perform data conversion for the communication. The simulation device of FIG. 10 may receive the program or the data from an external device via the network connection device 1307 and may use them by loading into the memory 1302.

The simulation device of FIG. 10 does not have to include all the constituents in FIG. 13, and a part of the constituents may be omitted depending on application or condition. For example, when no instruction and information have to be inputted from the operator or the user, the input device 1303 may be omitted. When the portable record medium 1309 or the communication network are not used, the medium drive device 1306 or the network connection device 1307 may be omitted.

Although the disclosed embodiments and their advantages are described in detail, those skilled in the art is able to perform various modification, addition, and omission without departing from the scope of the present disclosure clearly stated in the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable storage medium that stores a simulation program which simulates a synchronous transfer between a plurality of cores, the simulation program causing a computer to execute:
performing a processing for the synchronous transfer in each of the cores as a set of interrupt and interrupt wait processing;
simulating a cycle for the synchronous transfer at a timing when reception of notifications of the interrupts from all the plurality of cores is completed, and
synchronizing the cores by notifying the cores of interrupt responses to the interrupt wait processing executed in the cores at the timing.

2. The storage medium according to claim 1, wherein the simulation program causes the computer to further execute:
converting the processing for the synchronous transfer in each of the cores to the interrupt and the interrupt wait processing in advance of the performing and simulating.

3. The storage medium according to claim 1, wherein
in a simulation for each of the cores, when a core is notified of the interrupt response while executing the interrupt wait processing, the core waits for a predetermined number of cycles to perform the synchronous transfer and starts to execute a next processing command.

4. A simulation method performed by a computer for simulating a synchronous transfer between a plurality of cores, the method comprising:
performing processing for the synchronous transfer in each of the cores as a set of interrupt and interrupt wait processing;
simulating a cycle for the synchronous transfer at a timing when reception of notifications of the interrupts from all the plurality of cores is completed, and
synchronizing the cores by notifying the cores of interrupt responses to the interrupt wait processing executed in the cores at the timing.

5. A simulation apparatus for simulating a synchronous transfer between a plurality of cores, the apparatus comprising:
a memory; and
a processor coupled to the memory and configured to execute a process including:
performing processing for the synchronous transfer in each of the cores as a set of interrupt and interrupt wait processing; and
simulating a cycle for the synchronous transfer at a timing when reception of notifications of the interrupts from all the plurality of cores is completed, and synchronizing the cores by notifying the cores of interrupt responses to the interrupt wait processing executed in the cores at the timing.

6. The apparatus according to claim 5, the process further including:
performing a simulation for each of the plurality of cores;
extracting operation processing of a resource access of each of the plurality of cores from a result of the performing the simulation for each of the plurality of cores; and
converting the processing for the synchronous transfer in each of the cores to the interrupt and the interrupt wait processing in advance of the performing the simulation for each of the plurality of cores and the extracting.

7. A computer-implemented method for simulating performance of a Large Scale Integrated (LSI) circuit with a multi-core configuration, the method comprising:
receiving an application to be executed by a core simulator, the application resulting in at least one synchronous transfer between a plurality of cores of the multi-core LSI and at least one of the plurality of cores accessing, via a bus, at least one of a plurality of memories;
simulating execution of the application to obtain operation results for each of the plurality of cores;
extracting bus accesses from the operation results to generate operation files for the plurality of cores;
identifying a synchronous transfer between the plurality of cores based on the operation results;
converting, with a synchronous transfer converter, the operation files into converted operation files in which the synchronous transfer between the plurality of cores is replaced by a set of interrupt and interrupt wait processing;
simulating the performance of the LSI with a model simulator having a plurality of traffic generators corresponding to the plurality of cores, the model simulator executing the converted operation files; and
outputting a simulation result based on simulation performed by the model simulator.

8. The method according to claim 7, wherein the model simulator includes a interrupt controller connected to each of the plurality of traffic generators to provide transmit interrupt and wait for interrupt signals of the interrupt and interrupt wait processing.

9. The method according to claim 7, further comprising:
designing the hardware architecture of the LSI circuit with the multi-core configuration based on the output simulation result.
